(19) United States
(12) Patent Application Publication
(10) Pub. No.: US 2014/0149143 A1
(43) Pub. Date: May 29, 2014

(54) METHOD FOR PROVIDING PERSONALIZED DIETARY COMPLIANCE RATE BASED ON HEALTH INFORMATION

(71) Applicants: WELLTIZEN, Seoul (KR); GACHON UNIVERSITY OF INDUSTRY-ACADEMIC COOPERATION FOUNDATION, Seongnam-si (KR); GIL MEDICAL CENTER, Incheon (KR)

(72) Inventors: Gil Hwan Kim, Anyang-si (KR); Dong Kyun Park, Incheon (KR); Eun Young Jung, Incheon (KR); Byoung Hui Jeong, Incheon (KR); Byung Chan Moon, Incheon (KR); Taeg Keun Whangbo, Seongnam-si (KR); Sung Jong Eun, Seoul (KR); Jeong Won Kim, Gwangmyeong-si (KR); Dong Jin Kim, Seoul (KR); Yoon Young Park, Seoul (KR); Eui Hyun Jung, Seoul (KR); Yu Mi Lee, Incheon (KR)

(73) Assignees: WELLTIZEN, Seoul (KR); GACHON UNIVERSITY OF INDUSTRY-ACADEMIC COOPERATION FOUNDATION, Seongnam-si (KR); GIL MEDICAL CENTER, Incheon (KR)

(21) Appl. No.: 14/033,238

(22) Filed: Sep. 20, 2013

(30) Foreign Application Priority Data
Nov. 28, 2012 (KR) 10-2012-0136566

(51) Int. Cl. G06F 19/00

(52) U.S. Cl. CPC G06F 19/3475; G06F 19/3418
USPC 705/3

(57) ABSTRACT

A method and system provide personalized dietary compliance rate based on health information. The method may include: (a) transmitting health information from a hospital's information system to a service operating server; (b) identifying a disease using the health information by the service operating server; (c) selecting food in a user's terminal and determining the degree of correlation between the disease and nutrients of the selected food; and (d) determining dietary compliance rate based on the degree of correlation and providing the dietary compliance rate and the nutritional information of the food to the user's terminal. Dietary compliance rate can be provided via a mobile device and web, thus remote patient monitoring is possible, and consultation procedures are simplified using system's care information and on-line real-time Q & A. Additionally, due to continuous care, both physical and mental stability can be provided, increasing a patient's confidence.

### BACKGROUND OF THE INVENTION

1. Field of the Invention

The present invention relates to a method for providing dietary compliance, and more particularly to a method for determining personalized dietary compliance rate based on health information, in which the health information of the user is identified using a mobile device and web in places other than a special medical center in order to provide u-health health care services, and dietary compliance rate is determined based on the dietary therapy and dietary habit of a chronic disease patient and is provided to a user's portable terminal or a user's personal computer (PC).

2. Description of the Prior Art

With the recent development of telecommunication technology, u-health has emerged as a means for preventing chronic diseases and complications, and furthermore, studies focused on enabling the user to receive service to the user through health care contents at any time in any place have been conducted.

Due to the spread of the u-health concept, personalized health care services rather than standardized services are provided to a plurality of users, but there is a limit to information or input capable of satisfying the users.

In the case of many services that are currently provided, the user should directly input the user's own health conditions and personal information, and services are provided based on the input information. However, there is a limit to the range of information that is input directly by the user, and the contents of the input information are not verified. Thus, it is difficult to apply personalized contents and services.

To provide health care services, many systems, including web-based systems, IPTV-based systems and home monitoring systems, are used. However, unless the firm intention and motive of the user are imparted, continuous health care is difficult to achieve.

With increases in the quality of medical service and interest in preliminary medical examination, the consumer's desire to receive medical service using IT technology at any time in any place is increasing, and thus total care medical services that use IT technology together with electric home appliances and mobile devices are emerging.

In recent years, in Korea and other countries, there have been increasing interests in new systems constructed using increased amounts of information, including patient's personal data and clinical data, which overcome the limitations of the contents and uses of conventional paper medical records.

Important entities medical examination should be found by analyzing the generation and flow of general information associated with patient's information in hospitals, and a data structure should be logically designed based on the entity relation, and various screen inquiries suitable for various applications should be able to be performed using accumulated files.

The realization of computerization of medical records requires a large amount of time, and for this reason, electronic medical record (EMRs) developed based on computerized medical records in hospitals are used.

The EMR is a method in which all data are stored in computerized media in place of paper documents. In the EMR, the patient's personal data, prescription particulars, test results and the like are previously input as texts and are used during medical examination. Accordingly, only medical records written by medical specialists are input in computers, and thus more advanced electronic medical records can be constructed.

However, with the development of household or personal health devices together with the development of information processing technology, there has been a need to provide the user with medical service and/or dietary compliance rate personal health information such as EMR after identifying personal health information at home rather than special medical centers such as hospitals.

In addition, in general care methods that are controlled in one electronic medical record system, services such as personal dietary information and exercise program are provided according to a predetermined rule. In this case, only the same medical service and/or medical information is applied to the same health information, and thus the characteristics of the user are not considered. Accordingly, there has been a need for a method for providing personalized medical services and/or services that enable the identification of personal medical information.

### SUMMARY OF THE INVENTION

It is an object of the present invention to provide a method for providing a personalized dietary service based on health information, in which the dietary therapy and dietary habit of a chronic disease patient can be controlled by determining dietary compliance rate using a mobile device and web based on hospital's information provided from a hospital and analyzing the dietary pattern of the patient.

To achieve the above object, the present invention provides a method for providing personalized dietary compliance rate based on health information, the method comprising the steps of: (a) transmitting health information from a hospital's information system to a service operating server; (b) identifying a disease using the health information by the service operating server; (c) selecting food in a user's terminal and determining the degree of correlation between the disease and the nutrients of the selected food; and (d) determining dietary compliance rate based on the degree of correlation and providing the dietary compliance rate and the nutritional information of the food to the user's terminal.

The inventive method for providing personalized dietary compliance rate based on health information may further comprise, after step (b), determining whether anticancer therapy has been performed, by the service operating server, if the disease is cancer.

In the inventive method for providing personalized dietary compliance rate based on health information, the health information includes any one or more of a personal health record, an order communication system and an electronic medical record.

In the inventive method for providing personalized dietary compliance rate based on health information, step (b) may be performed by identifying any one or more of the name of the disease, the severity of the disease, the presence or absence of other diseases, and a treatment method.

In the inventive method for providing personalized dietary compliance rate based on health information, step (c) may be performed by determining the correlation according to the cooking form of the selected food.

In the inventive method for providing personalized dietary compliance rate based on health information, step (d) may further comprise providing personalized recommended food information regarding the disease using a dietary advice database (DB) stored in the service operating server.

In the inventive method for providing personalized dietary compliance rate based on health information, the dietary compliance rate may be determined based on information about dietary therapy for the disease, the mechanism and cause of the disease based on clinical nutrition, and nutrients that influence dietary therapy.

In the inventive method for providing personalized dietary compliance rate based on health information, the dietary compliance rate may be determined by grouping the suitability of the selected food, the calorie of amount of one of the food and the content of each nutritional component in the food by class intervals using a restaurant database (DB) and food database stored in the service operating server.

In the inventive method for providing personalized dietary compliance rate based on health information, the nutritional information may include calorie, the content of each nutritional component, and nutritional advice information.

In the inventive method for providing personalized dietary compliance rate based on health information, the user's terminal may include: a user's portable terminal that receives the dietary compliance rate using a mobile interface and a wireless internet network; a user's personal computer (PC) that receives the dietary compliance rate using a web interface and an internet network.

In the inventive method for providing personalized dietary compliance rate based on health information, the user's portable terminal may include: an area information GPS menu in which surrounding restaurants are displayed on a map based on a GPS, a restaurant is selected from the surrounding restaurants, and the menu list of the selected restaurant and the dietary compliance rate and nutritional information of each menu are displayed; a health QR menu in which the menu list and introduction information of the selected restaurant are displayed when a QR code scanned from a menu board is transmitted to the service operating server; a food photographing menu in which the dietary compliance rate and nutritional information of a photographed food are displayed when a photograph of the photographed food is transmitted to the service operating server; a food search menu in which a food list including food names that are input in a search window is displayed and the dietary compliance rate and nutritional information of the selected food are displayed; and a dietary guide content menu which receives the dietary compliance rate and in which a recommended menu, a non-recommended food and a dietary guide including a dietary habit correction guide are displayed.

In the inventive method for providing personalized dietary compliance rate based on health information, the user's personal computer (PC) may include: a diet record menu in which a food list including food names that are input in a search window, and the dietary compliance rate and nutritional information of the selected food are displayed, and the intake of actually taken foods is stored in the service operating server; a dietary guide content menu which receives the dietary compliance rate and in which a recommended menu, a non-recommended food, a dietary guide including a dietary habit correction guide, and a personalized recipe guide are displayed; and a patient information menu in which the health information transmitted from the hospital's information system to the service operating server is displayed.

### BRIEF DESCRIPTION OF THE DRAWINGS

FIG. 1 is a block diagram showing a system for providing personalized dietary compliance rate based on health information according to the present invention.

FIG. 2 is a block diagram showing a service operating server 300 in a system for providing personalized dietary compliance rate based on health information according to the present invention.

FIG. 3 is a flow chart showing the operation of a method for providing personalized dietary compliance rate based on health information according to the present invention.

FIG. 4 is a table showing nutrients that are applied for each disease according to the inventive method for providing personalized dietary compliance rate based on health information.

FIG. 5 is a flow chart showing determining dietary compliance rate for depression according to the inventive method for providing personalized dietary compliance rate based on health information.

FIG. 6 is a flow chart showing providing a mobile service through a user's portable terminal 420 according to an embodiment of the inventive method for providing personalized dietary compliance rate based on health information.

FIGS. 7 to 11 are images that are displayed on a user's portable terminal 420 when an area information GPS menu, a health QR menu, a food photographing menu, a food search menu and a dietary guide content menu are selected from the mobile service menus shown in FIG. 6.

FIG. 12 is a flow chart showing providing a web service through a user's personal computer 440 according to another embodiment of the inventive method for providing personalized dietary compliance rate based on health information.

FIGS. 13 to 15 are images that are displayed on a user's personal computer (PC) 440 when a diet record menu, a dietary guide content menu and a patient information menu are selected from the web service menus shown in FIG. 12.

### DETAILED DESCRIPTION OF THE INVENTION

Hereinafter, the inventive method for providing personalized dietary compliance rate based on health information will be described with reference to the accompanying drawings.

As used herein, the term “health information” refers to a collection of the PHR, OCS and EMR data stored in a hospital's information database (DB) unit in a hospital's information system.

As used herein, PHR is a personal health record and refers to a collection tools that allow an individual to inspect the personal health information and suitably apply the information to the person.

As used herein, OCS is an order communication system and refers to a system that transmits a database (DB), which stores a variety of medical information and the medical examination data of patients, and an order determined by a doctor, to each medical department through a communication network.

As used herein, EMR is an electronic medical record and refers to a method in which all data are stored in computerized media in place of paper documents that are used in hospitals.

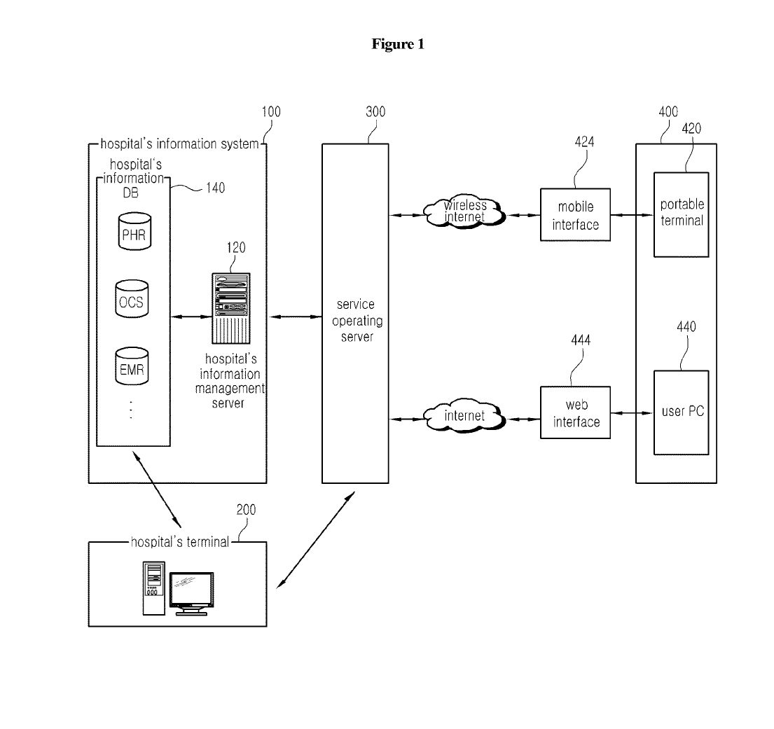

FIG. 1 is a block diagram showing a system for providing personalized dietary compliance rate based on health information according to the present invention. As shown in FIG. 1, the system comprises a hospital's information system 100, a hospital's terminal 200, a service operating server 300 and a user's terminal 400.

The hospital's information system 100 comprises a hospital's information management server 120 and a hospital's information database (DB) unit 140, and the hospital's information DB unit 140 includes PHR, OCS, EMR and the like.

The user's terminal 400 includes a user's portable terminal 420 and a user's personal computer (PC) 440.

The schematic operation of the system for providing personalized dietary compliance rate based on health information according to the present invention will now be described with reference to FIG. 1.

In the hospital's terminal 200, health information based on the results of health examination of the user, surgery, anticancer therapy and the like are stored in the hospital's information DB unit 140 of the hospital's information system 100 in the form of PHR, OCS or EMR.

When the user's terminal 400 is logged in, the mobile service or web service of the present invention is started by the service operating server 300 connected to the hospital's information system.

The service operating server 300 receives the stored user's health information through the hospital's information management server 120 of the hospital's information system 100, receives food photographs or food names from the user's terminal 400, determines the dietary compliance rates of the user for the foods, and provides disease-specific contents, including compliance rate, nutritional information and dietary guide, to the user's terminal 400.

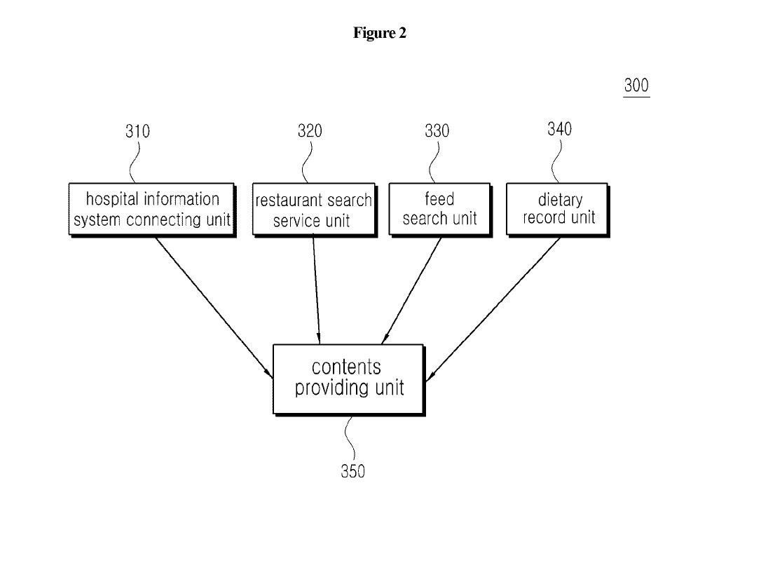

FIG. 2 is a block diagram showing a service operating server 300 in a system for providing personalized dietary compliance rate based on health information according to the present invention. As shown in FIG. 2, the service operating server 300 comprises a hospital's information system connecting unit 310, a restaurant search unit 320, a food search unit 330, a dietary record unit 340 and a contents providing unit 350.

The general operation of the service operating server 300 in the system for providing personalized dietary compliance rate based on health information according to the present invention will now be described with reference to FIG. 2.

The hospital's information system connecting unit 310 receives the health information and disease information of the user from the PHR, OCS and EMR data stored in the DB unit 140 of the hospital's information system 100.

The restaurant search unit 320 searches the position of a restaurant based on a GPS or searches a restaurant by recognition of a QR code and determines nutrients and dietary compliance rate for each menu of the restaurant.

The food search unit 330 determines calorie and nutrients by food photographing or food name search and determines the personalized dietary compliance rate of the user.

The dietary record unit 340 receives the intake record visually measured by the user.

The contents providing unit 350 receives the personalized dietary compliance rate of the user and provides disease-specific contents, including recommended menus, non-recommended menus and a dietary habit correction guide.

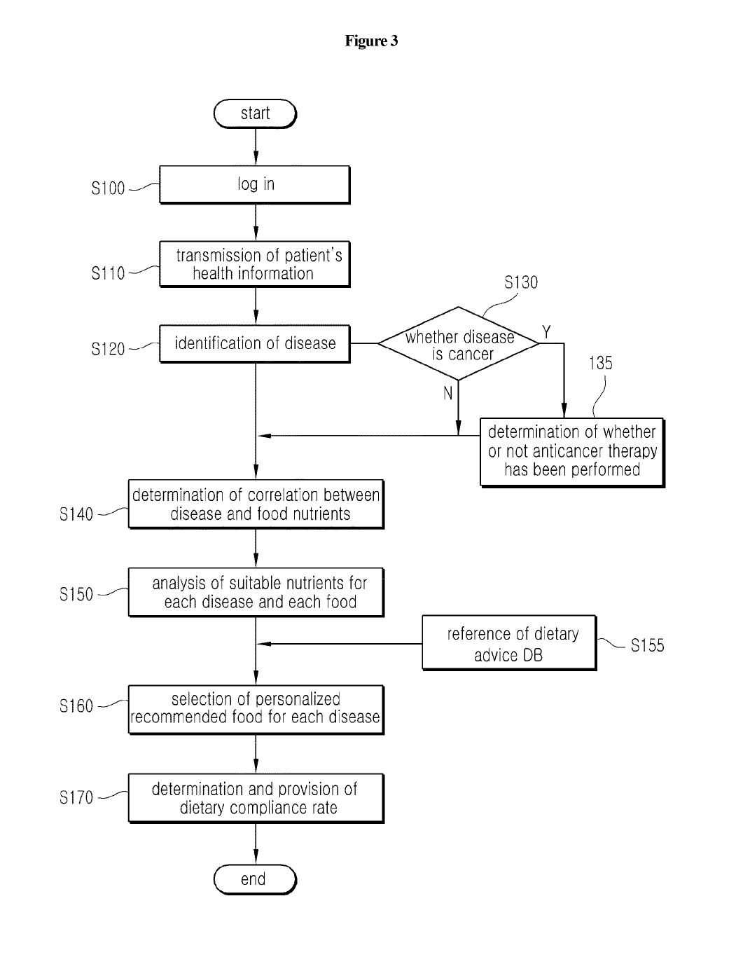

FIG. 3 is a flow chart showing the operation of a method for providing personalized dietary compliance rate based on health information according to the present invention.

The operation of the method for providing personalized dietary compliance rate based on health information according to the present invention will now be described with reference to FIGS. 1 to 3.

When the user logs in the user's terminal 400, the service is started by the service operating server 300 connected to the hospital's information system (S100).

The hospital's information system transmits the user's health information to the service operating server 300 (5110), and then the service operating server 300 receives the user's health information and indentifies the user's disease with reference to hospital's information, including PHR, OCS and EMR (S120).

Specifically, the service operating server 300 identifies the user's disease by collecting information about the user's disease name, the disease's condition (slight or serious), the presence or absence of other diseases, a treatment method, etc.

Herein, the service operating server 300 determines whether or not the user's disease is cancer (S130). If the disease is not cancer (S140), the server 300 determines the correlation between the disease and nutrients (S140). If the disease is cancer, the server 300 determines whether anticancer therapy has been performed (S135), and then determines the correlation between the disease and nutrients.

Herein, nutrient reference values that are applied according to each disease are based on daily dietary intakes and recommended dietary allowances, and specific factors for the user's disease condition are determined in consideration of the applied value.

Then, nutrients, including carbohydrates, proteins, fats and other components, contained in the food selected by the user, are identified and applied according to the cooking form of the food.

Suitable nutrients are analyzed for each disease and each food (S150), and a dietary advice database (DB) stored in the service operating server 300 is referred to (S155), and recommended food information for each disease is provided (S160), after which a dietary prescription program is executed to determine dietary compliance rate which is then provided to the user's terminal 400 (S170).

Herein, the dietary compliance rate is determined in the form of dietary compliance rate rate (%) for each disease, which indicates the suitability of nutrients of a food for each disease, based on examined data associated with dietary therapy for each disease, clinical nutrition, and the influences of nutrients on the mechanism and cause of development of each disease and on dietary therapy.

In addition, the dietary compliance rate is determined based on the stored restaurant DB and dietary DB using a menu selected by the user, the suitability of the selected food, calorie per person, and the content of each nutrient. Also, nutrients that are commonly applied in dietary prescription programs are selected, and the suitability of the nutrients for each disease is grouped by class intervals in consideration of percent recommended dietary allowances (% RDA), and the ratio of nutrients for each disease is determined for each food.

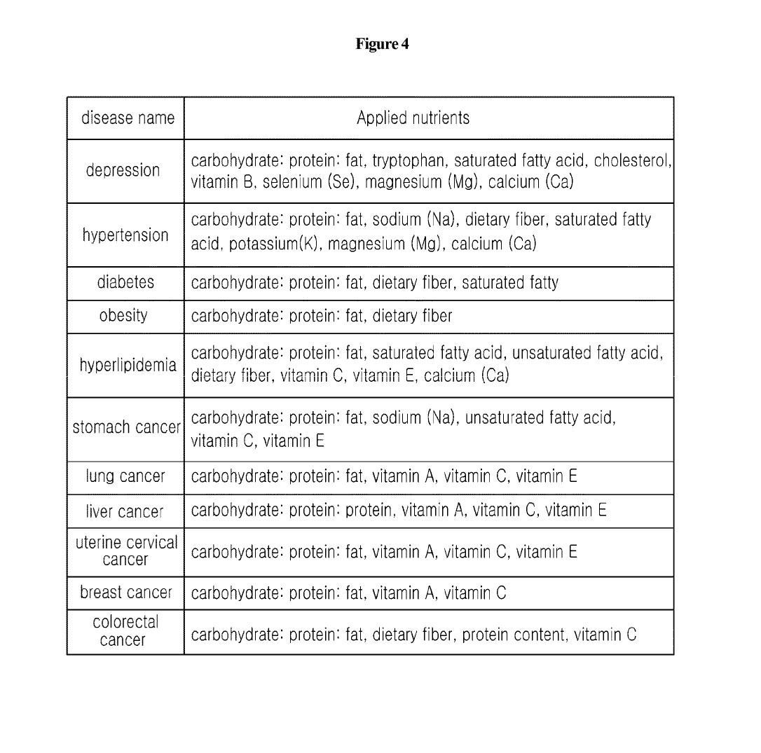

FIG. 4 is a table showing nutrients that are applied for each disease according to the inventive method for providing personalized dietary compliance rate based on health information.

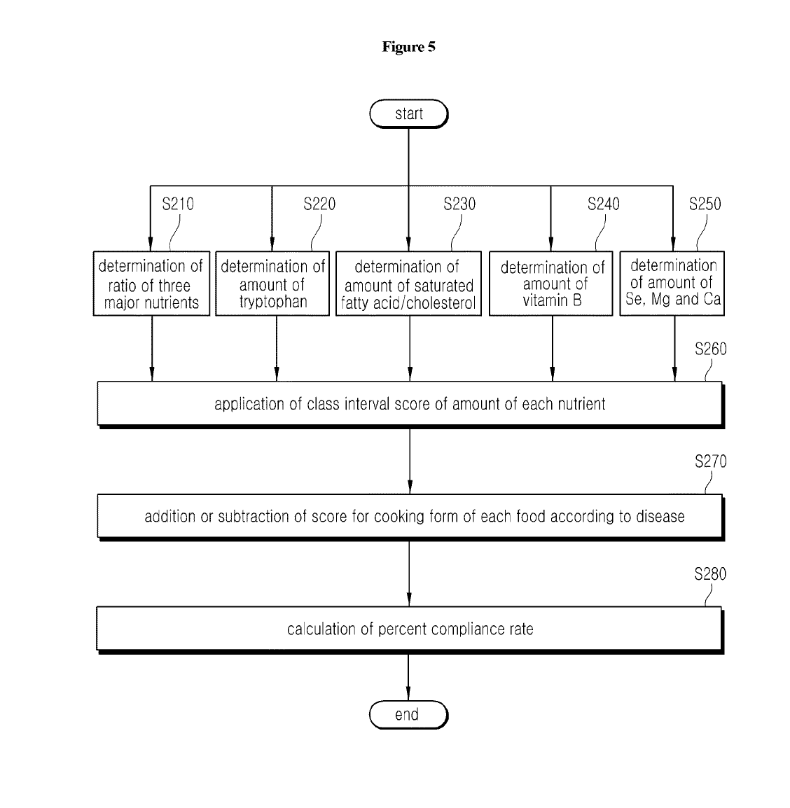

FIG. 5 is a flow chart showing determining dietary compliance rate for depression according to the inventive method for providing personalized dietary compliance rate based on health information.

The operation of a method for determining dietary compliance rate for depression according to the inventive method for providing personalized dietary compliance rate based on health information will now be described with reference to FIGS. 1 to 5.

As shown in FIG. 4, in a method for dietary compliance rate for each of 11 diseases, 16 nutrients, including carbohydrate, protein, fat, saturated fatty acid, unsaturated fatty acid, tryptophan, cholesterol, vitamin A, vitamin B, vitamin C, vitamin E, selenium (Se), magnesium (Mg), calcium (Ca), sodium (Na) and dietary fiber, which are commonly applied in a dietary prescription program, are selected, and the ratio of each nutrient that is applied for each disease is determined for each food.

Herein, the 11 diseases include depression, hypertension, diabetes, obesity, hyperlipidemia, stomach cancer, lung cancer, liver cancer, uterine cervical cancer, breast cancer and colorectal cancer.

A process for determining dietary compliance rate for depression among the 11 diseases is performed in the following manner. As shown in FIG. 5, the ratio of three major nutrients (carbohydrate, protein and fat), the amount of tryptophan (precursor of serotonin), the amount of saturated fatty acid, the ratio of cholesterol, the amount of vitamin B and the amount of selenium (Se), magnesium (Mg) and calcium (Ca) are determined as values (S210 to S250).

Percent daily dietary allowances (% RDA) are given in three divided meals, and the content of each nutrient is grouped by class intervals and applied to the score (S260). Then, the score for the cooking form of each food according to depression is added or subtracted (S270). Finally, the compliance rate (%) of the food containing the relevant nutrient for depression is calculated using an equation (S280).

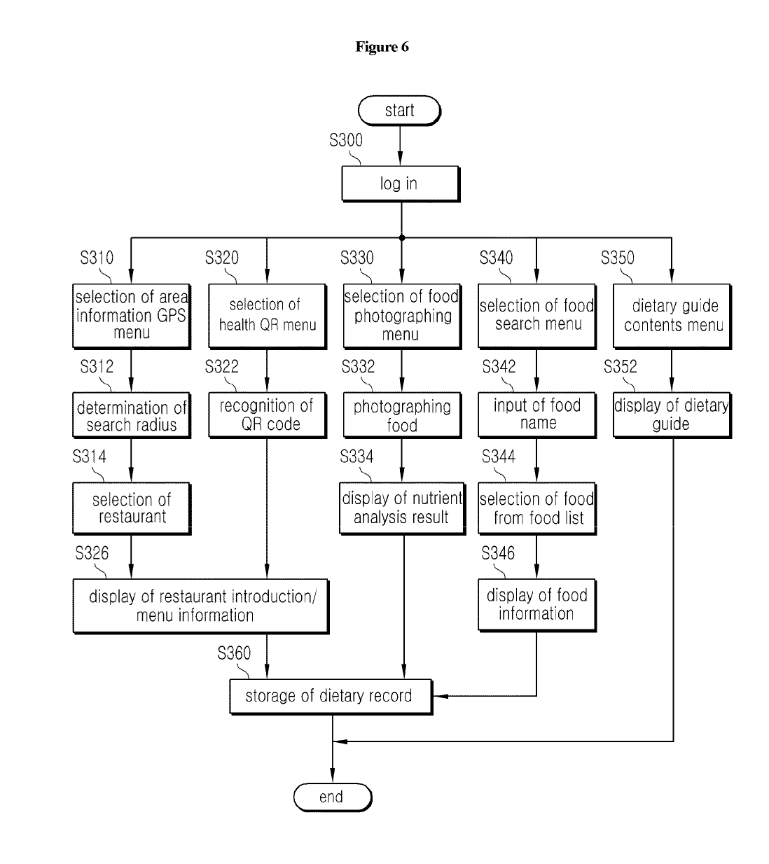

FIG. 6 is a flow chart showing providing a mobile service through a user's portable terminal 420 according to an embodiment of the inventive method for providing personalized dietary compliance rate based on health information.

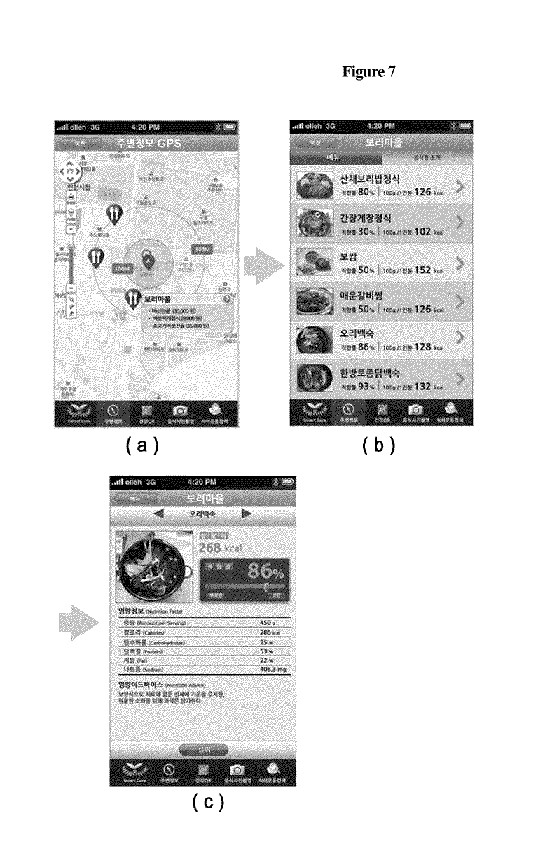

FIGS. 7 to 11 are images that are displayed on a user's portable terminal 420 when an area information GPS menu, a health QR menu, a food photographing menu, a food search menu and a dietary guide content menu are selected from the mobile service menus shown in FIG. 6.

The operation of a mobile service according to an embodiment of the inventive method for providing personalized dietary compliance rate based on health information will now be described with reference to FIGS. 1 to 3 and FIGS. 6 to 11.

As used herein, the term “displayed” refers to displayed on the screen of the user's portable terminal 420 using a mobile interface 424 and a wireless internet network.

When the user logs in the user's portable terminal 420 in order to use the mobile service (S300), the mobile service is started by the service operating server 300 connected to the hospital's information system, and mobile service menus are displayed.

If the area information GPS menu is selected (S310) and the search radius is set (S312), as shown in FIG. 7(a), the current position of the user is recognized, and a map of surrounding restaurants is displayed.

If a given restaurant is selected from the surrounding restaurants (S314), as shown in FIG. 7(b), the menu list of the selected restaurant and the compliance rate information and calorie information of the user for each menu are displayed.

If a given menu is selected from the menu list, as shown in FIG. 7(c), information about the calorie, nutrient content and nutrient advice of the selected menu is displayed (S326).

If the user clicks the “intake” button at the lower portion of FIG. 7(c) after intake of the selected menu, the fact that the menu was taken is stored in a dietary record unit 340 (S360).

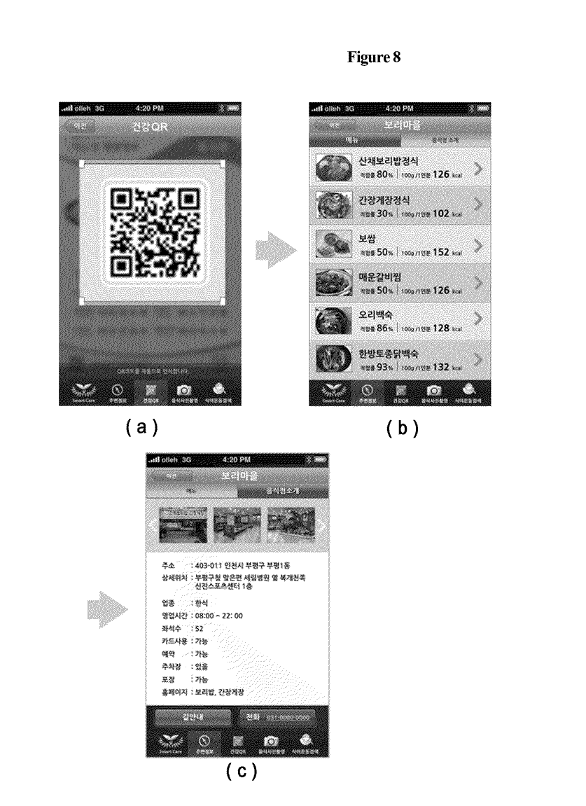

If a QR code is present on the menu board of the selected restaurant, the user can select a health QR menu (S320) and scan the QR code as shown in FIG. 8(a).

If the QR code on the menu board is scanned, it is recognized by the user's portable terminal 420 and transmitted to the service operating server 300, and as shown in FIGS. 8(b) and 8(c), and the menu list and introduction information of the selected restaurant are displayed (S326).

In the case in which the user desires to inform other persons of the accurate position of the restaurant and guide the road, when the user clicks a road guidance button at the lower portion of FIG. 8(c), an accurate map, road and transportation means to reach the restaurant are displayed.

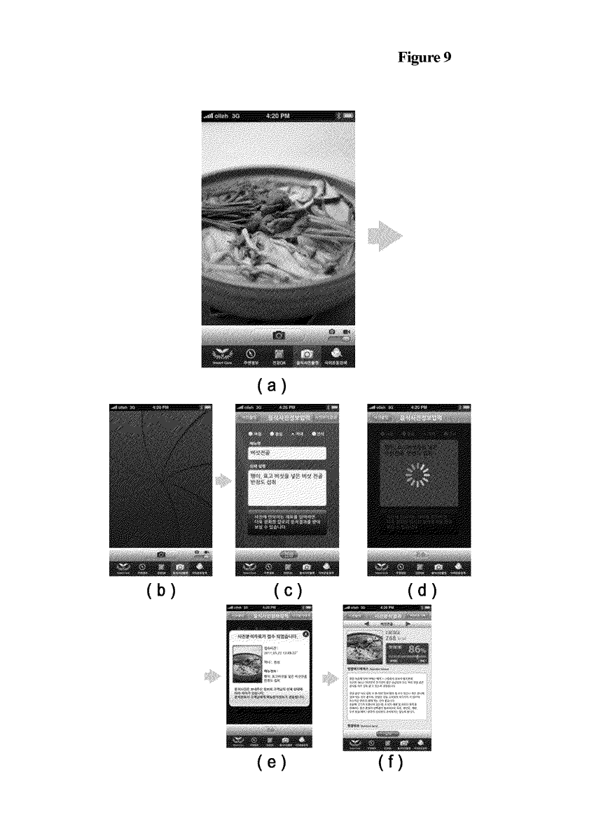

Then, if the user selects a food photographing menu (S330), photographs the food as shown in FIGS. 9(a) to 9(d), inputs the information of the photograph and clicks a transmission button (S332), the receipt of the photograph information and the calorie, compliance rate, nutritional advice information and other nutritional information of the photographed menu are displayed as shown in FIGS. 9(e) and 9(f) (S334).

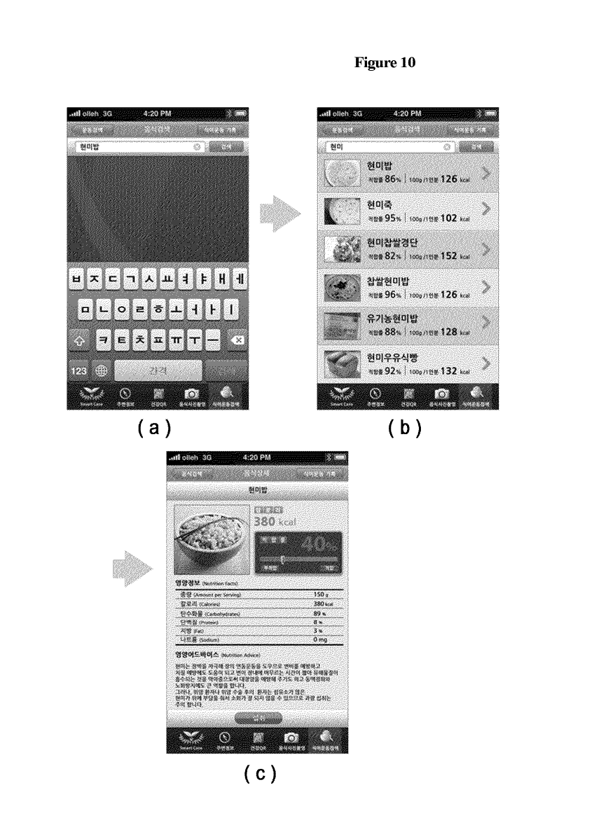

If a food search menu is selected (S340), a search window appears as shown in FIG. 10(a), and if the food name is input (S342), a searched food list including the food name is displayed as shown in FIG. 10(b).

If a given food is selected from the searched food list (S344), the calorie, compliance rate, nutritional advice information and other nutritional information of the selected food are displayed as shown in FIG. 10(c) (S346).

If the user clicks a “intake” button at the lower portion of FIG. 10(c) after actual intake of the selected food, the fact that the food was taken is stored in the dietary record unit 340 (S360).

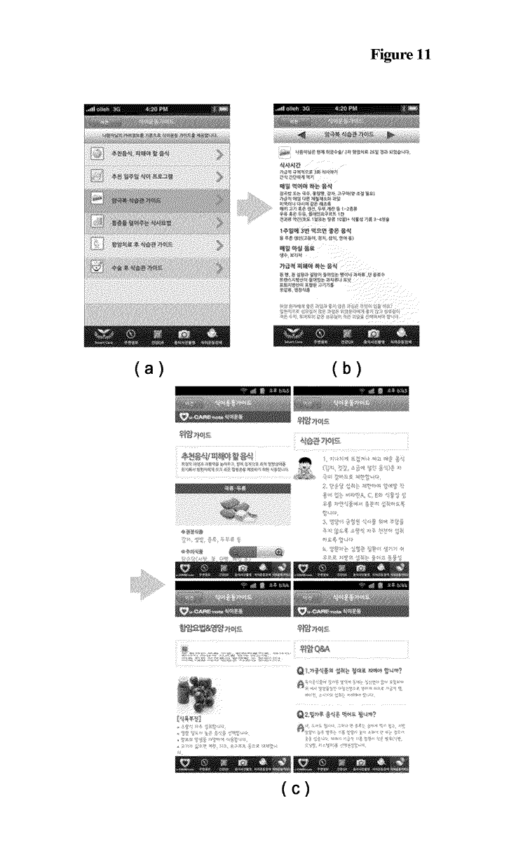

If a dietary guide content menu is selected (S350), as shown in FIG. 11(a), a dietary guide list including recommended foods, foods to be avoided, a recommended weekly dietary program, an anticancer dietary habit guide, a dietary therapy that reduces pain, a dietary habit guide after anticancer therapy and a dietary habit guide after surgery are displayed (S352).

For example, if the anticancer dietary habit guide is selected, as shown in FIGS. 11(b) and 11(c), mealtime, a food that should be taken daily, a recommended food, a food to be avoided, an anticancer therapy and nutrient guide, a dietary habit guide and stomach Q & A are displayed.

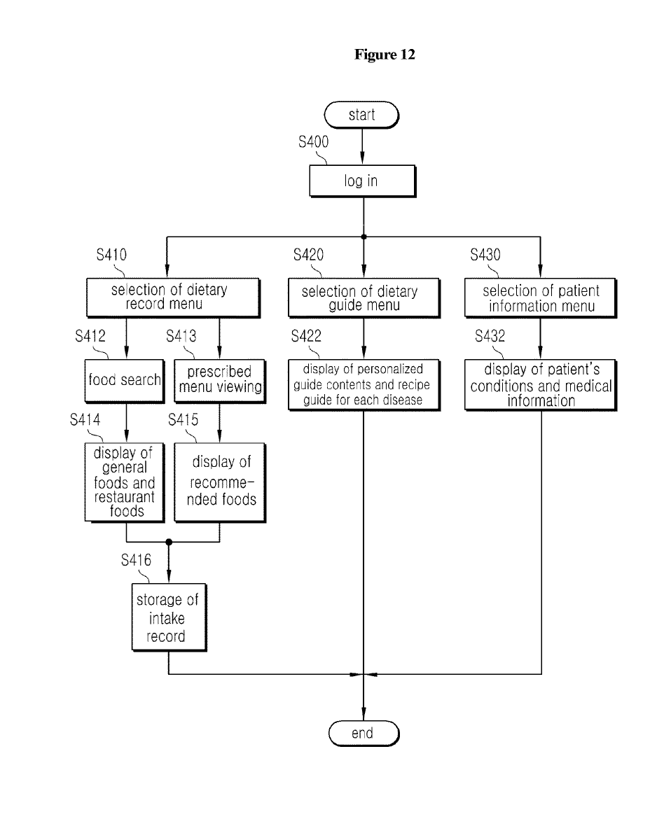

FIG. 12 is a flow chart showing providing a web service through a user's personal computer 440 according to another embodiment of the inventive method for providing personalized dietary compliance rate based on health information.

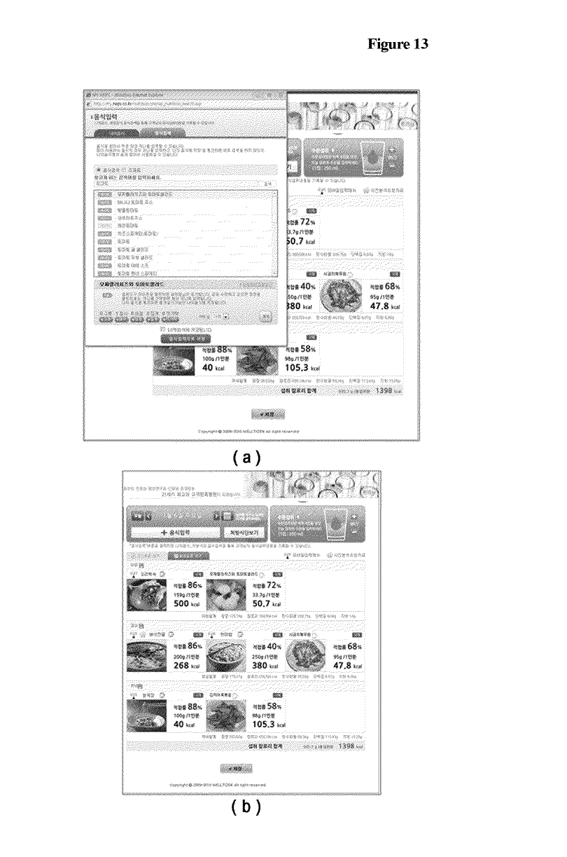

FIGS. 13 to 15 are images that are displayed on a user's personal computer (PC) 440 when a diet record menu, a dietary guide content menu and a patient information menu are selected from the web service menu shown in FIG. 12.

The operation of the web service according to another embodiment of the inventive method for providing personalized dietary compliance rate based on health information will now be described with reference to FIGS. 1 to 3 and FIGS. 13 to 15.

As used hereinafter, the term “displayed” refers to displayed on the screen of the user's PC 440 using a web interface 444 and an internet network.

When the user logs in the user's PC 440 in order to use the web service (S400) is started by the service operating server 300 connected to the hospital's information system, and web service menus are displayed.

If the dietary record menu is selected (S410), as shown in FIG. 13(a), a search window appears, and if the name of the food to be taken is input (S412), a searched food list including the food name is displayed (S414).

If a given food is selected from the searched food list, as shown in FIG. 13(b), the compliance rate and the sum of calorie and taken calorie of each of the input foods are displayed.

If a ‘prescription view button’ in FIG. 13(b) is clicked (S413), recommended foods provided by the service operating server 300 are displayed (S415).

If the user clicks a ‘storage’ button at the lower portion of FIG. 13(b) after actual intake of the foods displayed on the monitor, the fact that the foods displayed on the monitor were taken is stored in the dietary record unit 340 (S416).

If the dietary guide menu is selected (S420), recommended menus, foods to be avoided, and a personalized dietary guide for each disease for a dietary habit collection guide are displayed and a personalized recipe guide is also displayed (S422).

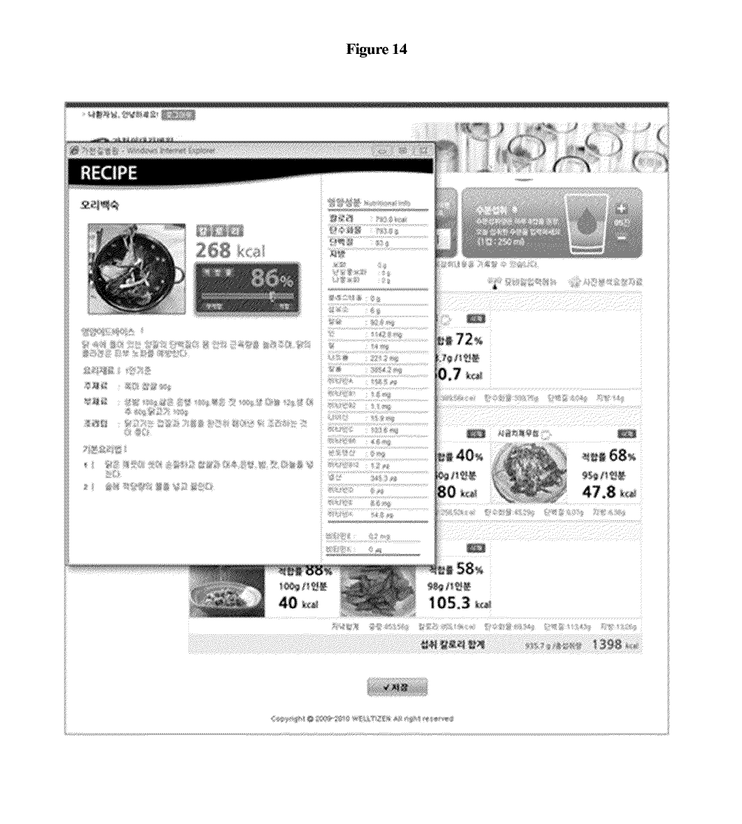

For example, if the selected menu is a ‘boiled duck’, as shown in FIG. 14, the calorie, compliance rate, nutritional advice information, materials and nutrients of the boiled duck are displayed.

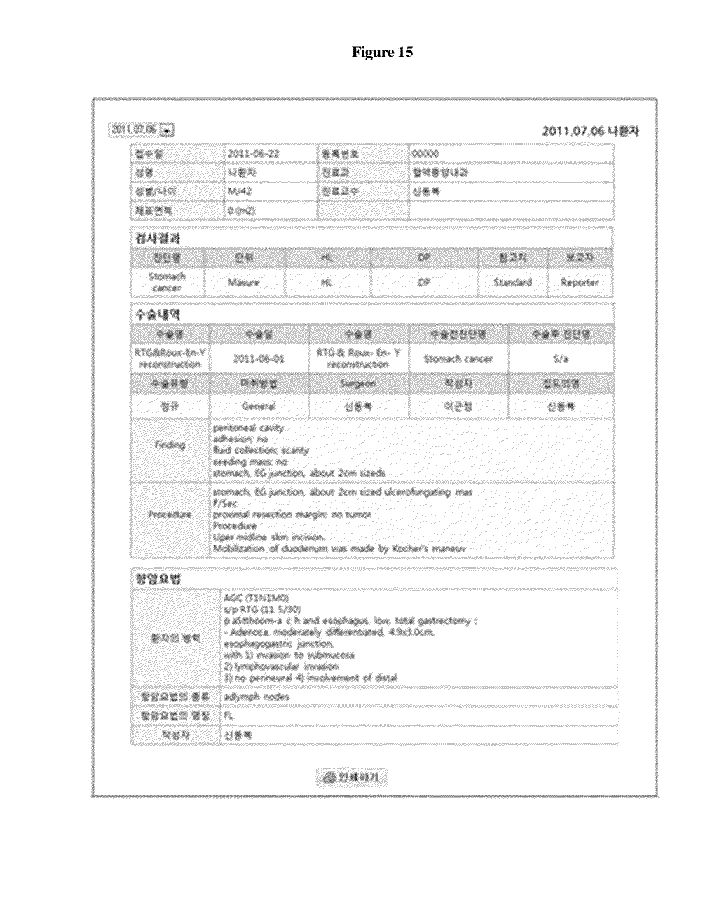

If the patient's information menu is selected (S430), as shown in FIG. 15, the health information transmitted from the hospital's information system to the service operating server 300, that is, the user's personal data, examination results, surgery, anticancer therapy and the like, are displayed (S432).

As described above, according to the inventive method for providing personalized dietary compliance rate based on health information, dietary compliance rate can be provided using a mobile device and web based on hospital's information, and the dietary therapy and dietary habit of a chronic disease patient can be managed by analyzing a personal dietary pattern. Accordingly, the user can be provided with a dietary care service at any time in any place, and thus remote patient monitoring is possible, and consultation procedures for the patient are simplified using system's care information and on-line real-time Q & A. In addition, due to continuous care, both physical and mental stability can be provided to the patient to increase the patient's confidence.

Although the preferred embodiments of the present invention have been described for illustrative purposes, those skilled in the art will appreciate that various modifications, additions and substitutions are possible, without departing from the scope and spirit of the invention as disclosed in the accompanying claims.

1. A method for providing personalized dietary compliance rate based on health information, the method comprising the steps of:
(a) transmitting health information from a hospital's information system to a service operating server;
(b) identifying a disease using the health information by the service operating server;
(c) selecting food in a user's terminal and determining the degree of correlation between the disease and nutrients of the selected food; and
(d) determining dietary compliance rate based on the degree of correlation and providing the dietary compliance rate and the nutritional information of the food to the user's terminal.

2. The method of claim 1, further comprising, after step (b), determining whether or not anticancer therapy has been performed, by the service operating server, if the disease is cancer.

3. The method of claim 1, wherein the health information includes any one or more of a personal health record, an order communication system and an electronic medical record.

4. The method of claim 1, wherein step (b) is performed by identifying any one or more of the name of the disease, the severity of the disease, the presence of other diseases, and a treatment method.

5. The method of claim 1, wherein step (c) is performed by determining the correlation according to the cooking form of the selected food.

6. The method of claim 1, wherein step (d) further comprises providing personalized recommended food information regarding the disease using a dietary advice database (DB) stored in the service operating server.

7. The method of claim 1, wherein the dietary compliance rate is determined based on information about dietary therapy for the disease, the mechanism and cause of development of the disease based on clinical nutrition, and nutrients that influence dietary therapy.

8. The method of claim 1, wherein the dietary compliance rate is determined by grouping the suitability of the selected food for the disease, the calorie of amount of one of the food and the content of each nutritional component in the food by class intervals using a restaurant database (DB) and food database stored in the service operating server.

9. The method of claim 1, wherein the nutritional information includes calorie, the content of each nutritional component, and nutritional advice information.

10. The method of claim 9, wherein the user's terminal includes:
a user's portable terminal that receives the dietary compliance rate using a mobile interface and a wireless internet network;
a user's personal computer (PC) that receives the dietary compliance rate using a web interface and an internet network.

11. The method of claim 10, wherein the user's portable terminal includes:
an area information GPS menu in which surrounding restaurants are displayed on a map based on a GPS, a restaurant is selected from the surrounding restaurants, and the menu list of the selected restaurant and the dietary compliance rate and the nutritional information of each menu are displayed;
a health QR menu in which the menu list and introduction information of the selected restaurant are displayed when a QR code scanned from a menu board is transmitted to the service operating server;
a food photographing menu in which the dietary compliance rate and the nutritional information of a photographed food are displayed when a photograph of the photographed food is transmitted to the service operating server;
a food search menu in which a food list including food names that are input in a search window is displayed and the dietary compliance rate and the nutritional information of the selected food are displayed; and
a dietary guide content menu which receives the dietary compliance rate and in which a recommended menu, a non-recommended food and a dietary guide including a dietary habit correction guide are displayed.

12. The method of claim 10, wherein the user's personal computer (PC) includes:
a diet record menu in which a food list including food names that are input in a search window, and the dietary compliance rate and the nutritional information of the selected food are displayed, and the intake of actually taken foods is stored in the service operating server;
a dietary guide content menu which receives the dietary compliance rate and in which a recommended menu, a non-recommended food, a dietary guide including a dietary habit correction guide, and a personalized recipe guide are displayed; and
a patient information menu in which the health information transmitted from the hospital's information system to the service operating server is displayed.

13. The method of claim 1, wherein the user's terminal includes:
a user's portable terminal that receives the dietary compliance rate using a mobile interface and a wireless internet network;
a user's personal computer (PC) that receives the dietary compliance rate using a web interface and an internet network.

14. The method of claim 2, wherein the user's terminal includes:
a user's portable terminal that receives the dietary compliance rate using a mobile interface and a wireless internet network;
a user's personal computer (PC) that receives the dietary compliance rate using a web interface and an internet network.

15. The method of claim 3, wherein the user's terminal includes:
a user's portable terminal that receives the dietary compliance rate using a mobile interface and a wireless internet network;
a user's personal computer (PC) that receives the dietary compliance rate using a web interface and an internet network.

16. The method of claim 4, wherein the user's terminal includes:
a user's portable terminal that receives the dietary compliance rate using a mobile interface and a wireless internet network;
a user's personal computer (PC) that receives the dietary compliance rate using a web interface and an internet network.

17. The method of claim 5, wherein the user's terminal includes:
a user's portable terminal that receives the dietary compliance rate using a mobile interface and a wireless internet network;
a user's personal computer (PC) that receives the dietary compliance rate using a web interface and an internet network.

18. The method of claim 6, wherein the user's terminal includes:
a user's portable terminal that receives the dietary compliance rate using a mobile interface and a wireless internet network;
a user's personal computer (PC) that receives the dietary compliance rate using a web interface and an internet network.

19. The method of claim 7, wherein the user's terminal includes:
a user's portable terminal that receives the dietary compliance rate using a mobile interface and a wireless internet network;
a user's personal computer (PC) that receives the dietary compliance rate using a web interface and an internet network.

20. The method of claim 8, wherein the user's terminal includes:
a user's portable terminal that receives the dietary compliance rate using a mobile interface and a wireless internet network;
a user's personal computer (PC) that receives the dietary compliance rate using a web interface and an internet network.
